(19) United States
(12) Patent Application Publication
(10) Pub. No.: US 2026/0116715 A1
(43) Pub. Date: Apr. 30, 2026

(54) DUAL ACTION JACK

(71) Applicant: Pro Eagle LLC, Torrance, CA (US)

(72) Inventors: Benson Su, Torrance, CA (US); Molly Vermeer, Los Angeles, CA (US)

(21) Appl. No.: 18/930,813

(22) Filed: Oct. 29, 2024

(51) Int. Cl. B66F 5/04

(52) U.S. Cl. CPC B66F 5/04

(57) ABSTRACT

A dual action jack having a hydraulic assembly. Hydraulic assemblies of the inventive subject matter are configured to allow a jack to raise a lifting surface on both the upstroke and down stroke of a jacking lever. Hydraulic assemblies have two pistons that can be compressed to move hydraulic fluid from a reservoir to a ram hydraulic fluid chamber to extend a ram. Each piston has a corresponding check valve assembly that allows hydraulic fluid to flow only along a desired pathway. Additionally, a release valve is provided to release hydraulic fluid from the ram assembly, enabling the ram to return to a resting position.

### FIELD OF THE INVENTION

The field of the invention is hydraulic jacks.

### BACKGROUND

The background description includes information that may be useful in understanding the present invention. It is not an admission that any of the information provided in this application is prior art or relevant to the presently claimed invention, or that any publication specifically or implicitly referenced is prior art.

Hydraulic jacks have been widely used in various industries for lifting heavy loads, including automotive, construction, and manufacturing sectors. These tools are essential for tasks that require elevating substantial weights efficiently and safely. However, traditional hydraulic jacks predominantly operate by lifting only during one phase of their operational cycle-typically the downstroke. This single-action motion has led to certain limitations in efficiency and effectiveness, especially in applications requiring repetitive lifting and lowering actions. For example, in the realm of offroad jacks, because many offroad vehicles have high ground clearance, it can take a long time to extend a jack before it begins to engage with and lift the vehicle.

Reliance on a unidirectional lifting mechanism means that the upstroke phase is essentially wasted energy, as it only serves to reset the jack for the next lifting motion. In many industrial applications, there is a significant need for jacks that can lift not only during the upstroke but also during the downstroke. Such a dual-action capability would enhance operational efficiency, reduce cycle times, and improve overall quality and user experience.

Existing designs fail to address this dual-action requirement, leaving a gap in the market for more advanced hydraulic jacks that can perform lifting actions in both directions. Moreover, a dual-action hydraulic jack would offer greater flexibility and control in lifting operations, allowing for smoother and more precise movements. This could be particularly beneficial in delicate tasks where the risk of damaging the load or the surroundings must be minimized.

Thus, there is still a need in the art for a hydraulic jack that lifts on both the upstroke and the downstroke.

### SUMMARY OF THE INVENTION

The present invention provides apparatuses, systems, and methods directed to dual action jacks, where a lifting surface is raised on both the up- and downstrokes of a jacking lever. In one aspect of the inventive subject matter, a hydraulic assembly for a dual action jack comprises: a first piston; a first check valve assembly hydraulically coupled with the first piston; a second piston; a second check valve assembly hydraulically coupled with the second piston; a ram assembly comprising a ram hydraulic fluid chamber, wherein the ram hydraulic fluid chamber is hydraulically coupled with the first piston via the first check valve assembly and with the second piston via the second check valve assembly; and a release valve configured to release hydraulic fluid from the ram assembly to allow a ram to return to a resting position.

In some embodiments, the hydraulic assembly further comprises a jacking lever receiver having a first piston roller mechanism and a second piston roller mechanism, where the first piston roller mechanism is configured to compress the first piston upon lifting a jacking lever that is inserted into the jacking lever receiver and where the second piston roller mechanism to is configured to compress the second piston upon lowering the jacking lever.

The first check valve assembly can include a first check valve and a second check valve. In some embodiments, the first check valve is disposed between a hydraulic fluid reservoir and the first piston, and the second check valve is disposed between the first piston and the ram hydraulic fluid chamber. The second check valve assembly can have a third check valve and a fourth check valve, where the third check valve is disposed between the hydraulic fluid reservoir and the second piston, and the fourth check valve is disposed between the second piston and the ram hydraulic fluid chamber.

In another aspect of the inventive subject matter, a hydraulic assembly for a dual action jack comprises: a first piston; a second piston; and a ram assembly comprising a ram hydraulic fluid chamber and a hydraulic fluid reservoir, where the hydraulic fluid reservoir is hydraulically coupled with the first piston and with the ram hydraulic fluid chamber via a first check valve assembly, and where the hydraulic fluid reservoir is hydraulically coupled with the second piston and with the ram hydraulic fluid chamber via a second check valve assembly.

In some embodiments, the hydraulic assembly also has a release valve configured to release hydraulic fluid from the ram assembly to allow a ram to return to a resting position from an extended position. Embodiments can also include a jacking lever receiver having a first piston roller mechanism and a second piston roller mechanism, wherein the first piston roller mechanism is configured to compress the first piston upon lifting a jacking lever inserted into the jacking lever receiver and wherein the second piston roller mechanism to is configured to compress the second piston upon lowering the jacking lever.

In some embodiments, the hydraulic assembly also includes a jacking lever receiver having a first piston roller mechanism and a second piston roller mechanism, where the first piston roller mechanism is configured to compress the first piston upon lifting a jacking lever that is inserted into the jacking lever receiver and where the second piston roller mechanism to is configured to compress the second piston upon lowering the jacking lever.

The first check valve assembly can include a first check valve and a second check valve, where the first check valve is disposed between a hydraulic fluid reservoir and the first piston, and the second check valve is disposed between the first piston and the ram hydraulic fluid chamber. The second check valve assembly can include a third check valve and a fourth check valve, where the third check valve is disposed between the hydraulic fluid reservoir and the second piston, and the fourth check valve is disposed between the second piston and the ram hydraulic fluid chamber.

One should appreciate that the disclosed subject matter provides many advantageous technical effects including the ability to create jacks that raise a lifting surface on both the upstroke and downstroke of a jacking lever.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a side view of a jack with its lifting surface all the way down.

FIG. 2 is a side view of the jack in FIG. 1 with its lifting surface partially raised.

FIG. 3 shows a jack of the inventive subject matter without its wheels.

FIG. 4 shows the jack from FIG. 3 from a different angle.

FIG. 5 shows a close-up view of the jack in FIG. 3 to show its hydraulic assembly.

FIG. 6 shows the hydraulic assembly of the jack in FIG. 3.

FIG. 7A shows a top view of the hydraulic assembly indicating cross sections A-A, B-B, and C-C.

FIG. 7B shows cross section A-A featuring upper piston 224.

FIG. 7C shows cross section B-B, which focuses on lower piston 216.

FIG. 7D shows cross section C-C, which focuses on upper piston check valve 254.

FIG. 8 is a hydraulic schematic showing how each component of a hydraulic assembly is connected.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Embodiments of the inventive subject matter are directed to an advanced jack system designed to lift a payload with both upward and downward movements of a jacking lever. Jacks described in this application comprise various components, including a lifting surface, lifting arm, jacking lever, and hydraulic assembly. Jacks of the inventive subject matter feature unique hydraulic assemblies that give rise to its unique mode of operation. Jacks described in this application have an upper piston and a lower piston, each with its own check valve, that are configured to raise a lifting surface on both an upward movement and a downward movement of a jacking lever.

By enabling jacks to lift on both the upstroke and the downstroke of a jacking lever's action, a lifting surface can be raised much more quickly than in traditional jacks that only raise a lifting surface on a downstroke. This saves time and energy and is especially useful in the context of offroad jacks where lifted vehicles can sometimes take a while to reach with a jack's lifting surface.

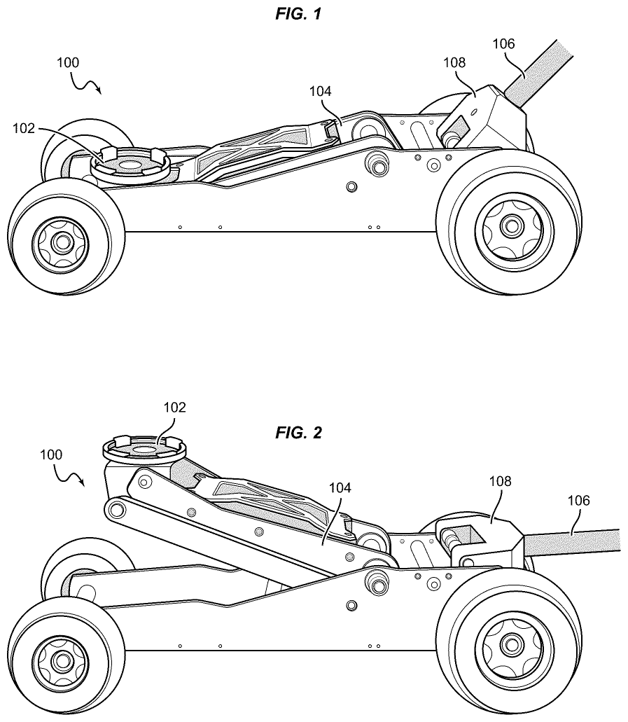

FIG. 1 shows a jack of the inventive subject matter fully at rest (e.g., zero extension). Jack 100 comprises lifting surface 102, lifting arm 104, jacking lever 106, and hydraulic assembly 108. When jacking lever 106 is lifted up or pressed down, hydraulic assembly 108 causes lifting arm 104 to extend upward, which causes lifting surface 102 to rise. FIG. 2 shows jack 100 in a partially extended configuration. Lifting arm 104 is partially extended upward, resulting in lifting surface 102 being partially raised.

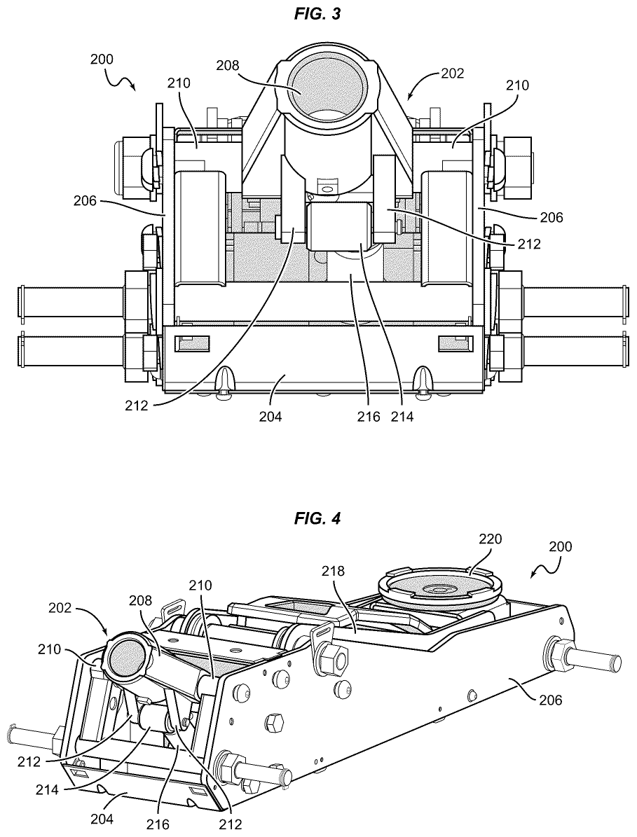

FIG. 3 shows another jack of the inventive subject matter. Jack 200 is shown without any wheels and without a lifting arm for purposes of focusing more on hydraulic assembly 202. From this angle, bottom skid plate 204 is shown, as well as side walls 206. Several parts of hydraulic assembly 202 are also visible. Jacking lever receiver 208 extends from cross member 210. Cross member 210 couples with side walls 206 such that jacking lever receiver 208 and cross member 210 can rotate when a user raises and lowers a jacking lever that fits into jacking lever receiver 208. Jacking lever receiver 208 has an interior space that is designed to accommodate an end of a universal joint that on its other end couples to a release valve (these are described in more detail below).

Attached to the bottom side of jacking lever receiver 208 is a lower piston roller mechanism. The lower piston roller mechanism has a holding frame 212 and a lower roller 214, where holding frame 212 holds lower roller 214 such that it can freely rotate. Lower roller 214 is positioned so that it interacts with lower piston 216 while pushing a jacking lever downward. When a jacking lever is pressed downward, lower roller 214 presses against lower piston 216 to compress it, forcing a working fluid into a lifting piston, and the lifting piston in turn raises a lifting arm and a lifting surface.

The lower piston roller mechanism is included to allow for compression of lower piston 216 without introducing any additional linkages between jacking lever receiver 208 and lower piston 216. Because jacking lever receiver 208 pivots about cross member 210, lower roller 214 moves along an arc. Thus, lower roller 214 presses against a surface of lower piston 216 and rolls along that surface as a jacking lever presses downward. To allow for smooth rolling, lower piston 216 comprises a flat surface that lower roller 214 rolls against. This eliminates need for a linkage between jacking lever receiver 208 and lower piston 216. FIG. 4 shows jack 200 from a different angle, showing lifting arm 218 and lifting surface 220.

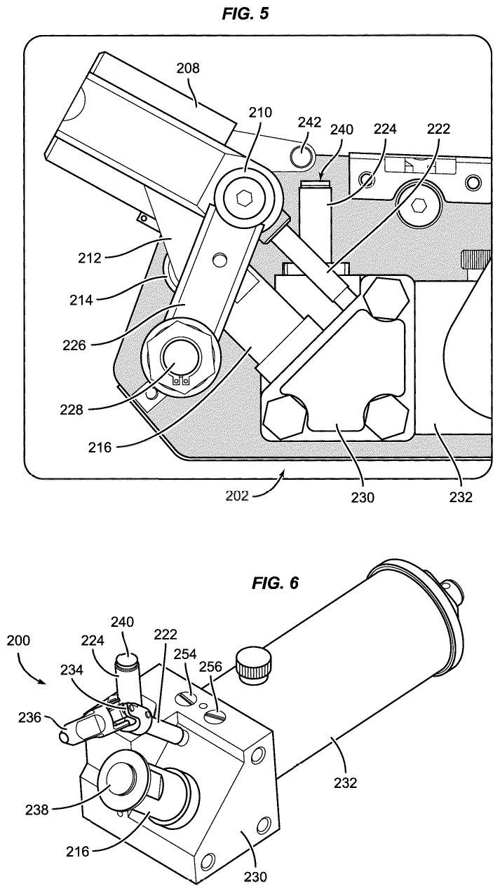

FIG. 5 shows a side view of jack 200 with a side wall removed to show hydraulic assembly 202. From this perspective, jacking lever receiver 208 is shown, along with holding frame 212, lower piston 216, and lower roller 214. This view also shows release valve stem 222 and upper piston 224. Upper piston 224 is shown having a flat surface 240 that is configured to give upper roller 242 a surface to press against while a jacking lever is being lifted. When upper roller 242 presses against flat surface 240, upper piston 224 is compressed. This action is the same as the action described above regarding lower piston 216.

Both rollers (upper and lower) described in this application can alternatively be made as components that do not have rollers. For example, they can be made instead to have a surface that presses against a corresponding piston during operation of a jack of the inventive subject matter. Rollers are used to reduce friction forces, so embodiments that just use curved surfaces would result in higher friction forces resisting movement, but those forces would be negligible considering the length of a typical jacking lever and the amount of sliding across a piston's surface that would occur during use.

This view also shows brace 226. Jack 200 includes two braces, but from this view only one brace is visible (the other is symmetrically disposed on the opposite side). Brace 226 couples with both cross member 210 and with axle 228, and it is configured to allow for forces resulting from a jacking lever being moved up and down to bring brace 226 into tension and compression. When brace 226 is in tension, it pulls against axle 228, which is fastened to side walls 206. When brace 226 is in compression, it presses against axle 228. Brace 226 offers added structural support to allow jack 200 to lift heavy loads.

FIG. 5 also shows hydraulic body 230 along with a portion of ram assembly 232. Hydraulic body 230 can be made from, e.g., a machined piece of stock material (e.g., steel, aluminum, or the like), and it comprises drilled out portions for different mechanisms to be inserted along with fluid pathways to connect different hydraulic components. For example, upper piston 224 can be screwed into a drilled and threaded hole in hydraulic body 230. The same is true for lower piston 216 as well as for release valve stem 222. In addition to pistons and a release valve, check valves are also incorporated into the hydraulic body. Discussion of check valves is included, below.

FIG. 6 shows the hydraulic assembly of jack 200. Shows release valve stem 222. Release valve stem 222 is shown having a universal joint 234 and a tapered end 236. Tapered end 236 includes a taper to make it easier for tapered end 236 to mate with a jacking lever when a jacking lever is inserted into a jacking lever receiver. Tapered end 236 has a square cross section that matches the cross-sectional shape of a hole at an end of a jacking lever, such that rotating the jacking lever causes rotation of release valve stem 222. When release valve stem 222 is turned in one direction, it closes a release valve allowing ram assembly 232 to be jacked up, and when release valve stem 222 is turned in the opposite direction, it opens the release valve allowing ram assembly 232 to return to an unextended resting position.

Lower piston 216 is shown with a flat surface 238. Flat surface 238 is described above as a surface against which a roller can press to compress lower piston 216, which causes ram assembly 232 to extend. Upper piston 224 is also shown having a flat surface 240. Flat surface 240 is described above as a surface against which a roller can press to compress upper piston 224, which causes ram assembly 232 to extend. Upper piston check valve 254 screws into hydraulic body 230, and it is configured to work in coordination with upper piston 224. When upper piston 224 is compressed, upper piston check valve 254 allows fluid to flow into ram hydraulic fluid chamber 246, and when upper piston 224 is allowed to return to a resting position, upper piston check valve 254 allows fluid to flow from hydraulic reservoir 250 into upper piston hydraulic chamber 244.

Lower piston check valve 256 also screws into hydraulic body 230, and it is configured to work in coordination with lower piston 216. When lower piston 216 is compressed, lower piston check valve 256 allows fluid to flow into ram hydraulic fluid chamber 246, and when upper piston 224 is allowed to return to a resting position, lower piston check valve 256 allows fluid to flow from hydraulic reservoir 250 into lower piston hydraulic chamber 252.

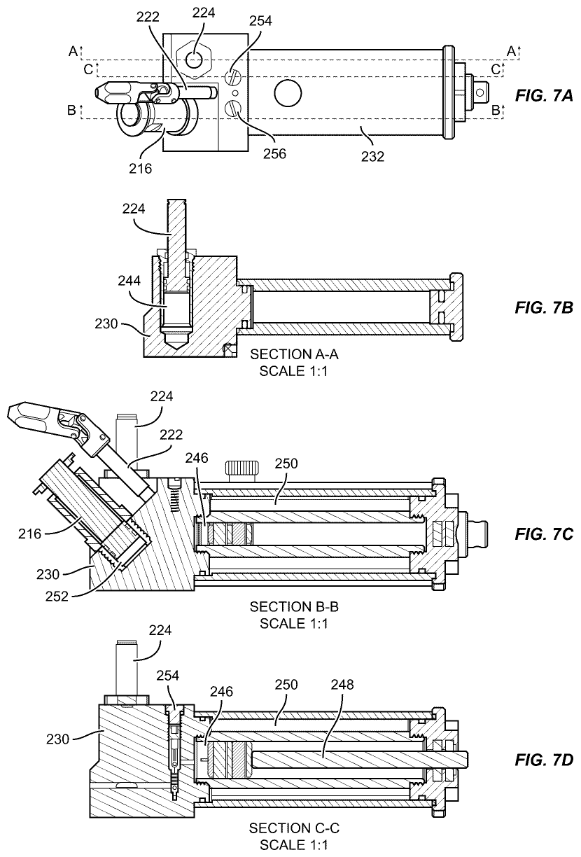

FIGS. 7A through 7D show the hydraulic assembly of jack 200. FIG. 7A shows the hydraulic assembly as seen from the top, and FIGS. 7B, 7C, and 7D show different cutaway views as indicated in FIG. 7A.

Thus, FIG. 7A shows upper piston 224, lower piston 216, release valve stem 222, and ram assembly 232. Upper piston 224, lower piston 216, and release valve stem 222 are disposed on hydraulic body 230. FIG. 7A also shows three cross section markers: A-A, B-B, and C-C.

FIG. 7B shows cross section A-A featuring upper piston 224. From this view, upper piston hydraulic chamber 244 is visible. When a jacking lever is lifted and upper piston 224 is pressed downward (as drawn), fluid is forced from the upper piston hydraulic chamber 244 into a ram hydraulic fluid chamber 246 to drive ram 248 (both shown in FIG. 7D). Ram 248 is part of ram assembly 232. When a jacking lever is pressed downward, upper piston 224 moves upward back to its resting position. This upward movement can be spring motivated, or it can be motived by hydraulic pressure from fluid reentering upper piston hydraulic chamber 244. As upper piston 224 moves back to its resting position, upper piston hydraulic chamber 244 fills with hydraulic fluid from hydraulic reservoir 250 (shown in FIGS. 7C and 7D).

FIG. 7C shows cross section B-B, which focuses on lower piston 216. Lower piston 216 is shown extending into lower piston hydraulic chamber 252. When lower piston 216 presses into lower piston hydraulic chamber 252, fluid from the chamber is pressed into ram hydraulic fluid chamber 246, which causes ram 248 to extend out of ram assembly 232. Similar to upper piston 224, lower piston 216 returns to a resting position (i.e., it extends outward) when jacking lever is lifted upward and pressure on lower piston 216 is removed. Lower piston 216 can be caused to extend back outward by, e.g., hydraulic pressure, spring pressure, and the like.

FIG. 7D shows cross section C-C, which focuses on upper piston check valve 254. Upper piston check valve 254 fits into a threaded hole that is drilled into hydraulic body 230. By screwing upper piston check valve 254 into the threaded hole, upper piston check valve 254 creates fluid pathways between hydraulic reservoir 250, upper piston 224, and ram hydraulic fluid chamber 246.

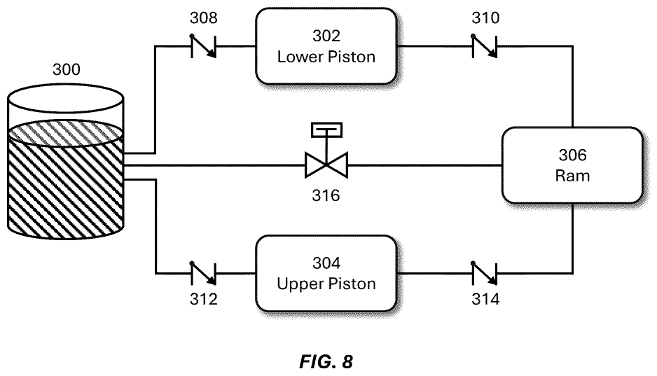

FIG. 8 is a schematic of the hydraulic assembly incorporated into jacks of the inventive subject matter (see, e.g., hydraulic assembly 202). Reservoir 300 is where hydraulic fluid is stored (see, e.g., hydraulic reservoir 250). Reservoir 300 is hydraulically coupled to both lower piston 302 (see, e.g., lower piston 216) and upper piston 304 (see, e.g., upper piston 224). Lower piston 302 and upper piston 304 are both coupled with ram 306 (see, e.g., ram 248), and ram 306 is hydraulically coupled with reservoir 300. Between reservoir 300 and lower piston 302 there is a first check valve 308. Between lower piston 302 and ram 306 there is a second check valve 310. Between reservoir 300 and upper piston 304 there is a third check valve 312. And between upper piston 304 and ram 306 there is a fourth check valve 314. Check valves allow hydraulic fluid to flow in only one direction, thus allowing hydraulic fluid from the reservoir to be pumped to the ram, causing it to extend. Use of check valves allows each piston to work independently from the other while still working together to pump hydraulic fluid to the ram. To allow ram 306 to return to its original, unextended position, release valve 316 (see, e.g., release valve stem 222) can be opened, allowing fluid to flow away from ram 306 and back to reservoir 300.

FIG. 8 shows four check valves, though only two check valves are described in the preceding figures. This is because check valves described above (like check valve 254) are compound in nature, where each individual check valve comprises two check valves. Taking check valve 254 as an example, in FIG. 7D two ball bearings with two biasing members (e.g., coil springs) are shown. Each ball bearing with a corresponding biasing member is representative of a single check valve despite being integrated into the same check valve assembly as a second check valve. Thus, for example, check valves 308 and 310 are integrated into the same assembly, and check valves 312 and 314 are integrated into the same assembly.

Thus, specific systems directed to dual action jacks have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A hydraulic assembly for a dual action jack, comprising:
a first piston;
a first check valve assembly hydraulically coupled with the first piston;
a second piston;
a second check valve assembly hydraulically coupled with the second piston;
a ram assembly comprising a ram hydraulic fluid chamber, wherein the ram hydraulic fluid chamber is hydraulically coupled with the first piston via the first check valve assembly and with the second piston via the second check valve assembly; and
a release valve configured to release hydraulic fluid from the ram assembly to allow a ram to return to a resting position.

2. The hydraulic assembly of claim 1, further comprising a jacking lever receiver having a first piston roller mechanism and a second piston roller mechanism, wherein the first piston roller mechanism is configured to compress the first piston upon lifting a jacking lever that is inserted into the jacking lever receiver and wherein the second piston roller mechanism to is configured to compress the second piston upon lowering the jacking lever.

3. The hydraulic assembly of claim 1, wherein the first check valve assembly comprises a first check valve and a second check valve.

4. The hydraulic assembly of claim 3, wherein the first check valve is disposed between a hydraulic fluid reservoir and the first piston, and the second check valve is disposed between the first piston and the ram hydraulic fluid chamber.

5. The hydraulic assembly of claim 4, wherein the second check valve assembly comprises a third check valve and a fourth check valve.

6. The hydraulic assembly of claim 5, wherein the third check valve is disposed between the hydraulic fluid reservoir and the second piston, and the fourth check valve is disposed between the second piston and the ram hydraulic fluid chamber.

7. A hydraulic assembly for a dual action jack, comprising:
a first piston;
a second piston; and
a ram assembly comprising a ram hydraulic fluid chamber and a hydraulic fluid reservoir, wherein the hydraulic fluid reservoir is hydraulically coupled with the first piston and with the ram hydraulic fluid chamber via a first check valve assembly, and wherein the hydraulic fluid reservoir is hydraulically coupled with the second piston and with the ram hydraulic fluid chamber via a second check valve assembly.

8. The hydraulic assembly of claim 7, further comprising a release valve configured to release hydraulic fluid from the ram assembly to allow a ram to return to a resting position from an extended position.

9. The hydraulic assembly of claim 7, further comprising a jacking lever receiver having a first piston roller mechanism and a second piston roller mechanism, wherein the first piston roller mechanism is configured to compress the first piston upon lifting a jacking lever inserted into the jacking lever receiver and wherein the second piston roller mechanism to is configured to compress the second piston upon lowering the jacking lever.

10. The hydraulic assembly of claim 7, further comprising a jacking lever receiver having a first piston roller mechanism and a second piston roller mechanism, wherein the first piston roller mechanism is configured to compress the first piston upon lifting a jacking lever that is inserted into the jacking lever receiver and wherein the second piston roller mechanism to is configured to compress the second piston upon lowering the jacking lever.

11. The hydraulic assembly of claim 7, wherein the first check valve assembly comprises a first check valve and a second check valve.

12. The hydraulic assembly of claim 11, wherein the first check valve is disposed between a hydraulic fluid reservoir and the first piston, and the second check valve is disposed between the first piston and the ram hydraulic fluid chamber.

13. The hydraulic assembly of claim 12, wherein the second check valve assembly comprises a third check valve and a fourth check valve.

14. The hydraulic assembly of claim 13, wherein the third check valve is disposed between the hydraulic fluid reservoir and the second piston, and the fourth check valve is disposed between the second piston and the ram hydraulic fluid chamber.
